(19) United States
(12) Patent Application Publication
(10) Pub. No.: US 2006/0140484 A1
(43) Pub. Date: Jun. 29, 2006

(54) Method and equipment for measuring feature points of wave signal

(76) Inventor: Takayuki Okochi, Koshigaya-shi (JP)

Correspondence Address: JORDAN AND HAMBURG LLP, 122 EAST 42ND STREET, SUITE 4000, NEW YORK, NY, 10168, US

(21) Appl. No.: 10/535,068

(22) PCT Filed: May 13, 2003
(86) PCT No.: PCT/JP03/05944

§ 371 Date: Dec. 12, 2005

(30) Foreign Application Priority Data
Nov. 13, 2002 (JP) 2002-330131

(51) Int. Cl. G06K 9/46

(52) U.S. Cl. 382/207

(57) ABSTRACT

A measuring method and equipment for detecting quickly and with high precision feature points (peak points or trough points) of a waveform even with waveform signals with irregular feature point values or irregular distances between feature points as in the density waveform signals or the like obtained from tree ring images or the like of wood specimens. In the measuring method and equipment, wavelet conversion of the waveform signal within a predetermined interval is performed by using a predetermined mother wavelet and multiple scale levels, squared mean for interval for each interval width corresponding to said scale levels is calculated in relation to a wavelet conversion signal for each scale level generated by the said wavelet conversion, a scale level at a point where the calculated value of the said squared mean for interval becomes maximum at an arbitrary point within the predetermined interval is decided as a dominant level for that point, and points at which the said waveform signal reaches maximum value or minimum value for each interval width corresponding to the dominant level are detected as the feature points of the waveform signal.

### FIELD OF THE INVENTION

The present invention relates to a method and equipment for detecting with excellent accuracy the feature points of wave signals with irregular feature point values on the waveform or irregular distance between feature points, and more specifically, relates to a method and equipment for measuring feature points of wave signals which can be ideally applied to the measurement of such objects as the number of tree rings in a piece of wood or the width of the tree rings.

### BACKGROUND ART

In the field of dendrochronology, it is possible to establish in annual units the year in which each of the tree rings in a given piece of wood was formed, by cross-referencing against a database of standard tree ring width fluctuations. This serves as the basis for tree ring dating. This database, brought about by the intensive efforts of the National Research Institute for Cultural Properties, Nara, now enables researchers in Japan to go back to 912 B. C. for hinoki cypress, and to 1313 B. C. for sugi cedar. Incidentally, in Germany, a nation that is at the forefront of dendrochronology, standard databases have been created with a span of approximately 10,000 years. The field of dendrochronology deals primarily with the following matters:
(a) Estimation of the year of felling of a piece of wood
(b) Estimation of the year of creation and course of repair of wooden cultural properties (architecture, Buddhist carvings, works of art and handicrafts, etc.); authentication; etc.
(c) Study of climatic changes over long periods of time in the past; study of global warming; etc.

The ultimate in detection performance is required of the time series data of each tree ring width that is used in dendrochronology: both erroneous detection (erroneously recognizing something that is not a tree ring as a tree ring) and non-detection (failing to recognize a tree ring) must be zero.

For this reason, the measurement of tree ring width has been carried out by the human eye, via specialized systems that use a measurement microscope. Such work has required a high level of skill and enormous amounts of time (approximately 1 hour for a specimen with 300 or so tree rings). The large scale of the system setup was another problem inherent in this method.

In an effort to automate the measuring work, methods have been considered wherein each tree ring width is measured using a personal computer to analyze tree ring images acquired using such image acquisition equipment as digital cameras and scanners. Several endeavors have been made along these lines to date, but the current situation is one in which problems such as the aforementioned detection performance requirements and large scale of the system, as well as price considerations, have kept such methods from becoming widespread as a means for research.

In particular, the problem with Japanese cypress (Hinoki) has been that, despite its wide use in cultural properties and hence its importance as a dendrochronological species, restrictions such as the narrowness of tree ring width and the indistinctness of tree rings compared to Japanese cedar (Sugi) cedar have made the practical application of automated measurement extremely difficult. The following are the major publicly known technologies that are similar to the present invention:

(1) “Win DENDRO,” Regent Instruments, Canada 1988 (see http://www.regent.qc.ca.products/dendro/DENDRO.html)

Designed by Dr. Rejean Gagnon and Dr. Hubert Morin of Quebec University and commercialized by Regent Instruments, this software was developed for dendrochronological research. This software is able to conduct tree ring measurement and wood tissue analysis on the basis of information on light intensity differences in the tree ring image. While the details of the algorithms of this software are unknown, as far as can be surmised from the wording in the company's catalogue, said software does not appear to use wavelet processing or technology to integrate information from multiple measuring lines.

(2) “Gazo shori shisutemu wo mochiita nenrin haba keisoku (Measurement of tree ring width using an image processing system),” Noda, Masato 1990: Presentation at the Tree Ring Society

This presentation concludes that, while it is possible to measure the tree rings of Japanese cedar (Sugi), it is impossible to measure those of Japanese cypress (Hinoki). Measurement methods relating to this presentation do not use wavelet processing or technology to integrate information from multiple measuring lines.

(3) Japanese Unexamined Patent Publication(Kokai) No. H 11-232427

There is a description of the use of light intensity information in the image to measure the number of tree rings; however, said technology is already publicly known due to (2) above. Neither wavelet processing nor technology to integrate information from multiple measuring lines is used in any way in the publicly known technology listed in this publication.

By acquiring pixel information from the tree ring image along a measurement line, it is possible to obtain waveform signals of information on light intensity changes and/or waveform signals of information on density changes. The maximum point of the density waveform (or in the case of the intensity waveform, the minimum point) corresponds to the darkest portion(the highest density late wood portion) of each tree ring layer. Therefore, by recognizing the maximum point of the density signal waveform or the minimum point of the light intensity waveform, it is possible to recognize each tree ring layer.

On the other hand, further treatment of the density waveform signal by differential processing makes the dark to light transition point (the minimum point of the differential waveform) correspond to the end point (late wood end) of each tree ring layer. Therefore, by measuring the distance between minimum points of the differential waveform signal on the measurement line, it is possible to measure tree ring width with greater accuracy.

The obtainment of waveform signals of information on light intensity changes and/or waveform signals of information on density changes by acquiring pixel information from the tree ring image along a measurement line is a publicly known matter due to the publicly known literature described above.

However, the tree ring widths of wood specimens are generally irregular, and it is not unusual to encounter up to 100-fold differences between the maximum tree ring width and minimum tree ring width. Therefore, when the detection accuracy for the feature points (the peak points, which are the maximum points, or the trough points, which are the minimum points) for the waveform signal obtained from the tree ring image is set to the level of detecting the small distances between feature points, the analysis is prone to picking up noise unrelated to tree rings in portions where the distances between feature points are large. On the other hand, when the detection accuracy for the feature points (the peak points or the trough points) for the waveform signal obtained from the tree ring image is set to the level of detecting the large distances between feature points, the analysis may fail to detect feature points. Therefore, it is difficult to measure with accuracy the number and width of tree rings in specimens with large differences between the minimum tree ring width and maximum tree ring width.

Furthermore, because the density level is not uniform in the tree ring image, it is often the case that the light intensity waveform signal, density waveform signal, differential waveform signal, etc. obtained from the tree ring image all have undulating features over the entire interval to be measured. For this reason, attempting to use a fixed threshold value to detect feature points (the peak points, which are the maximum points, or the trough points, which are the minimum points) in the waveform signal can result in a failure to detect feature points, leading to an inability to measure the number of tree rings or tree ring width with accuracy.

Therefore, a measurement method and equipment that allows for the speedy and highly precise acquisition of time series data on each tree ring width, which is the most basic data in the study of dendrochronology, is desired.

### DISCLOSURE OF THE INVENTION

In order to provide a method and equipment for measuring feature points of a waveform signal which can comply with the aforementioned desire, the present invention aims to provide a measurement method and equipment capable of speedy and high precision detection of waveform feature points even when a waveform signal has irregular feature point values or irregular distances between feature points.

In order to resolve the above-mentioned problems, the present invention, as the first invention, provides a method for measuring feature points of a waveform signal having irregular feature point values or irregular distances between the feature points, the method comprising the steps of: performing wavelet conversion of a waveform signal within a predetermined interval by using a predetermined mother wavelet and multiple scale levels; calculating squared mean for interval for each interval width corresponding to said scale levels in relation to a wavelet conversion signal for each scale level generated by the said wavelet conversion; defining a scale level at a point where the calculated value of the said squared mean for interval becomes maximum at an arbitrary point within the predetermined interval, as a dominant level for that point; and detecting points at which the said waveform signal reaches maximum value or minimum value for each interval width corresponding to the dominant level, as the feature points of the waveform signal.

Furthermore, as the second invention, in the measurement method having the constitution of the above-mentioned first invention, the present invention provides a method for measuring feature points of a waveform signal, wherein the aforementioned wavelet conversion uses the following formula (6), that is,
dⱼ(x)=b^{j}∫_{-∞}^{∞}φ(b^{j}(x−k))f(x)dx (6)
where f(x) is the waveform signal, ψ(x) is the mother wavelet, b^{j} is a scaling parameter, b is a constant (b>1), j is a scale level comprised of zero or a negative whole number, and k is a translating parameter.

Furthermore, as the third invention, in the measurement method having the constitution of the above-mentioned second invention, the present invention provides a method for measuring feature points of a waveform signal characterized in that the aforementioned mother wavelet uses a French hat wavelet transform which is defined by the following formula (7), that is,

$$ϕ ( x ) = \{ \begin{matrix}1 & - 1 \leq x \leq 1 \\ - 0.5 & - 3 \leq x < - 1 , or 1 < x \leq 3 \\ 0 & x < - 3 , or 3 < x\end{matrix} \qquad ( 7 )$$

Furthermore, as the fourth invention, in the measurement method having the constitution of the above-mentioned second invention, the present invention provides a method for measuring feature points of a waveform signal characterized in that the aforementioned mother wavelet is a Mexican hat wavelet transform which is defined by the following formula (8), that is,

$$ϕ ( x ) = - \frac{1}{2} \frac{{ⅆ}^{2}}{ⅆ {x}^{2}} {ⅇ}^{- {x}^{2}} = ( 1 - 2 {x}^{2} ) {ⅇ}^{- {x}^{2}} \qquad ( 8 )$$

Furthermore, as the fifth invention, in the measurement method having the constitution of the above-mentioned second invention, the present invention provides a method for measuring feature points of a waveform signal characterized in that the aforementioned calculation of the squared mean for interval uses the following formula (9), that is,
gⱼ(x)=2⁻¹pⱼ⁻¹∫ₓ₋ₚ_{ⱼ}^{x+p}^{ⱼ}|dⱼ(k)|²dk (9)
where j is the scale level used in the formula (6), k is the translating parameter, and pⱼ is a constant that is set according to scale level j so that the constant pⱼ becomes larger as the scale level j becomes lower.

Furthermore, as the sixth invention, in the measurement method having the constitution of the above-mentioned fifth invention, the present invention provides a method for measuring feature points of a waveform signal characterized in that pⱼ in the aforementioned formula (9) for the calculation of the squared mean for interval is defined by the following formula (10), that is,
pⱼ=b^{-j}a (10)
where a is a constant determined by the support of the mother wavelet ψ(x) used in the formula (6), b is the constant used in the formula (6), and j is the scale level used in the formula (6).

Furthermore, as the seventh invention, in the measurement method having the constitution of the above-mentioned second invention or fifth invention, the present invention provides a method for measuring feature points of a waveform signal characterized in that the value of b in the aforementioned formula (6) is 2.

Furthermore, as the eighth invention, in the measurement method having the constitution of the above-mentioned first invention, the present invention provides a method for measuring feature points of a waveform signal characterized in that the aforementioned waveform signal is a pixel light intensity or density information signal acquired from a target image, such as wood specimen tree ring image or the like, along a measurement line configured on the image.

Furthermore, as the ninth invention, in the measurement method having the constitution of the above-mentioned first invention, the present invention provides a method for measuring feature points of a waveform signal characterized in that the aforementioned waveform signal is a pixel light intensity or density information signal acquired from a target image, such as wood specimen tree ring image or the like, along a measurement line configured on the target image that is further subjected to differential processing.

Furthermore, as the tenth invention, in the measurement method having the constitution of the above-mentioned ninth invention, the present invention provides a method for measuring feature points of a waveform signal characterized in that the aforementioned differential processing is a calculus of finite differences between multiple pixels separated by an interval of several pixels.

Furthermore, as the eleventh invention, in the measurement method having the constitution of the above-mentioned eighth invention, the present invention provides a method for measuring feature points of a waveform signal characterized in that when the aforementioned waveform signal is a density information signal, said density information signal is f(x), the aforementioned dominant level is j_{d}, the constant corresponding to said dominant level is q_{jd}, and an arbitrary point on the aforementioned measurement line is x, then when the value of f(x) is equivalent to the maximum value fₘₐₓ(x) of f(x) of the interval [x−q_{jd}, x+q_{jd}], the point x is determined as the feature point which indicates the maximum density point within the tree ring layer.

Furthermore, as the twelfth invention, in the measurement method having the constitution of the above-mentioned ninth invention, the present invention provides a method for measuring feature points of a waveform signal characterized in that when the aforementioned waveform signal is a differential signal obtained by differential processing of a density information signal, the said differential signal is f(x), the aforementioned dominant level is j_{d}, the constant corresponding to said dominant level is q_{jd}, and an arbitrary point on the aforementioned measurement line is x, then when the value of f(x) is equivalent to the minimum value fₘᵢₙ(x) of f(x) of the interval [x−q_{jd}, x+q_{jd}], the point x is determined as the feature point which indicates the late wood end within the tree ring layer.

Furthermore, as the thirteenth invention, in the measurement method having the constitution of the above-mentioned eighth invention or ninth invention, the present invention provides a method for measuring feature points of a waveform signal characterized in that the aforementioned measurement line is comprised of a main measurement line and multiple subordinate measurement lines which are equidistant parallel lines on either side of said main measurement line, and when waveform signal feature points are detected at a point that is the same distance from the starting end on said main measurement line and subordinate measurement lines, then those feature points are determined to be a feature point on the main measurement line provided that one of the conditions is that the number of said feature points comprises at least a majority in relation to the number of measurement lines including the main measurement line and subordinate measurement lines.

Furthermore, as the fourteenth invention, in the measurement method having the constitution of the above-mentioned thirteenth invention, the present invention provides a method for measuring feature points of a waveform signal characterized in that two subordinate measurement lines are configured respectively at both sides of the aforementioned main measurement line, and when feature points of the waveform signal are detected at a point that is roughly the same distance from the starting end on the said main measurement line and subordinate measurement lines, and when feature points are found on the main measurement line and on at least one of the two subordinate measurement lines that are positioned adjacent to said main measurement line, and when feature points are found on the two subordinate measurement lines that are positioned adjacent to the main measurement line and on at least one of the other subordinate measurement lines, then those feature points are determined to be a feature point on the main measurement line.

Furthermore, as the fifteenth invention, in the measurement method having the constitution of the above-mentioned eighth invention or ninth invention, the present invention provides a method for measuring feature points of a waveform signal characterized in that a smoothing process using peripheral pixel information is performed on the pixel light intensity or density information acquired from the target image along the measurement lines configured on the target image.

Furthermore, as the sixteenth invention, the present invention provides an equipment for measuring feature points of a waveform signal having irregular feature point values or irregular distances between feature points, characterized by comprising: a wavelet conversion means for performing wavelet conversion of a waveform signal within the predetermined interval by using a predetermined mother wavelet and multiple scale levels; a squared mean calculation means for calculating squared mean for interval for each interval width corresponding to said scale levels in relation to the wavelet conversion signal for each scale level generated by the wavelet conversion means; a dominant level decision means for defining a scale level at which the calculated value of the aforementioned squared mean for interval becomes maximum at an arbitrary point within the aforementioned predetermined interval, as the dominant level for that point; and feature point detecting means for detecting points at which the aforementioned waveform signal reaches maximum value or minimum value for each interval width corresponding to the dominant level, as the feature points of the waveform signal.

Furthermore, as the seventeenth invention, in the measurement equipment having the constitution of the above-mentioned fifteenth invention, the present invention provides an equipment for measuring feature points of a waveform signal characterized by further comprising distance calculating means for calculating distances between the feature points on the basis of the detected feature points of the waveform signal.

### BRIEF DESCRIPTION OF THE DRAWINGS

FIG. 1 is a flow chart showing the first half of the process of the method for measuring feature points of a waveform signal according to one embodiment of the present invention applied to tree ring measurement.

FIG. 2 is a flow chart showing the second half of the process that follows the flow chart in FIG. 1.

FIG. 3 is an explanatory diagram showing typically an example of the configuration of the main measurement line and the subordinate measurement lines.

FIG. 4A is an explanatory waveform diagram of a RGB signal showing the manner in which the RGB signal acquired along the measurement line is converted into a density signal, FIG. 4B is an explanatory waveform diagram of a density signal generated from the RGB signal, and FIG. 4C is an explanatory diagram of the RGB-density conversion curve used in the conversion of the RGB signal into the density signal.

FIG. 5A is an explanatory waveform diagram showing the changes in the density signal, and FIG. 5B is an explanatory waveform diagram showing the density signal after smoothing.

FIG. 6A is an explanatory waveform diagram of the density signal, FIG. 6B is an explanatory waveform diagram of the differential signal generated by differential processing of the density signal, and FIG. 6C is an explanatory diagram for explaining the method of differential processing.

FIG. 7 is an explanatory waveform diagram showing an example of an extension dummy signal added to both sides of the density signal.

FIG. 8A is an explanatory diagram showing a typical example of the French hat type mother wavelet used in wavelet conversion, and FIG. 8B is an explanatory diagram showing a typical example of a Mexican hat type mother wavelet.

FIG. 9 is an explanatory diagram showing the manner in which the French hat type mother wavelet waveform changes in stages according to the level value.

FIG. 10 is an explanatory diagram showing the signal waveform that is obtained by wavelet conversion of the density signal using three graded level values.

FIG. 11 is an explanatory diagram showing the results of the processing of squared mean for interval according to the level value applied to the signal waveform obtained by the wavelet conversion shown in FIG. 10.

FIG. 12 is an explanatory diagram showing the results of the decision operation of the dominant level from the results of the processing of the squared mean for interval shown in FIG. 11.

FIG. 13A is an explanatory diagram of a dominant level showing schematically the process of searching and deciding the maximum value within the interval on the density signal waveform and the minimum value within the interval of the differential signal waveform, using the results of the dominant level determinant operation shown in FIG. 12, FIG. 13B is an explanatory waveform diagram of a density signal, and FIG. 13C is an explanatory waveform diagram of a differential signal.

FIG. 14A is an explanatory diagram showing the results of the detection of the maximum density point (feature point) from the density signal, and FIG. 14B is an explanatory diagram showing the results of the detection of the late wood end point (feature point) from the differential signal.

FIG. 15 is an explanatory diagram showing schematically the process of establishing a detection point (feature point) by cross-referencing of the main measurement line and subordinate measurement lines.

FIG. 16 is an explanatory diagram showing schematically the process of establishing a detection point (feature point) by cross-referencing of the subordinate measurement lines following the process in FIG. 15.

FIG. 17 is an explanatory diagram showing schematically the final result of the process of establishing a detection point (feature point) by cross-referencing following the process in FIG. 16.

### BEST MODE FOR CARRYING OUT THE INVENTION

Preferred embodiments of the present invention will now be described with reference to the drawings.

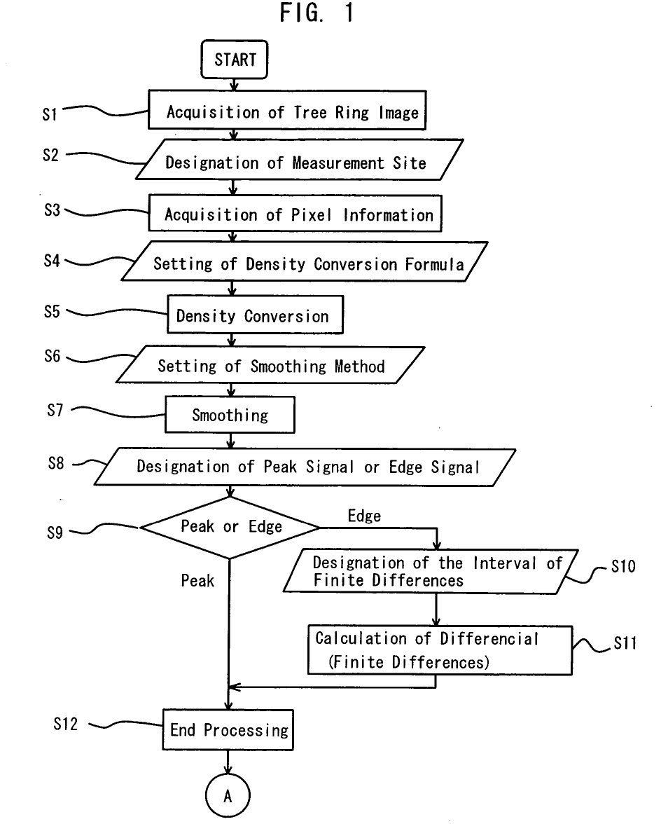

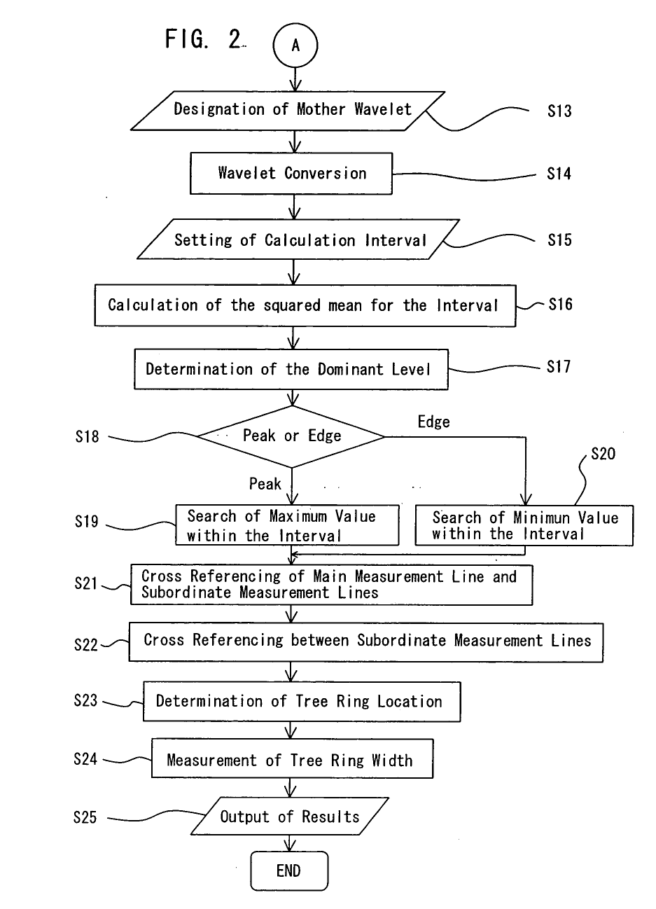

FIG. 1 and FIG. 2 are flow charts showing one embodiment of the method for measuring feature points of a waveform signal according to the present invention applied to a tree ring measurement. Referring to FIG. 1 and FIG. 2, the process of tree ring measurement is comprised of the following steps:

1. Acquisition of Tree Ring Image (Step S1)

2. Designation of Measurement Site (Step S2)

3. Acquisition of Pixel Information (Step S3)

4. Density Conversion (Steps S4 and S5)

5. Smoothing (Steps S6 and S7)

6. Acquisition of Peak Signal or Edge Signal (Steps S8 through S12)

7. Designation of Mother Wavelet (Step S13)

8. Wavelet Conversion (Step S14)

9. Calculation of Squared Mean for Interval (Steps S15 and S16)

10. Determination of Dominant Level (Step S17)

11. Determination of Maximum Value within Interval (in the case of edge signal, the minimum value within the interval) (Steps S18 through S20)

12. Cross-referencing of Main Measurement Line and Subordinate Measurement Lines (Step S21)

13. Cross-referencing between Subordinate Measurement Lines (Step S22)

14. Determination of Tree Ring Location (Step S23)

15. Measurement of Tree Ring Width and Output of Results (Steps S24 and S25)

Furthermore, the equipment for measuring feature points of a waveform signal according to one embodiment of the present invention is a program which is capable of executing the above process from step S2 through step S25, and becomes capable of execution by installing into a computer device such as a personal computer into which an operating system has been installed.

The program in this embodiment comprises: means for designating a measurement site, means for acquiring pixel information, means for performing density conversion, means for smoothing, means for acquiring peak signal or edge signal, means for designating mother wavelet, means for performing wavelet conversion, means for calculating squared mean for interval, means for deciding dominant level, means for deciding maximum value within the interval (in the case of edge signal, the minimum value within the interval), means for cross-referencing of main measurement line and subordinate measurement lines, means for cross-referencing between subordinate measurement lines, means for deciding tree ring location, means for measuring tree ring width, and means for outputting results.

Next, each of the above processes will be described in detail.

1. Acquisition of Tree Ring Image (Step S1)

The tree ring image is acquired using imaging equipment such as a digital camera, scanner, or the like. For example, specimens which are small and portable can be imaged by scanner, while large specimens can be imaged by high resolution digital camera. Here it is most important to pay attention to obtaining the required image resolution. Hinoki cypress specimens may present tree ring widths that are as narrow as approximately 0.1 mm per layer at places. In order to distinguish these portions, according to the Nyquist Sampling Theorem the size per pixel should be set at or under 0.05 mm, which is half of that width.

Furthermore, in consideration of safety and measurement margin of error, it is preferable to conduct image acquisition at a resolution of 1,200 dpi, which is equivalent to the approximately 0.02 mm size of each pixel. In order to maintain this resolution over the entire measurement area of a large-size specimen, it is preferable to use the method of limiting the imaging area of each frame, and connecting the frames together.

The tree ring images handled in the present invention can be, in addition to images obtained directly from the specimen surface using digital image acquisition equipment as described above, images of film photographs (photographs made using regular film), etc. that have been digitally converted. In addition, tree ring images inside the specimen can also be used, such as x-ray photographs, x-ray CT images (x-ray tomograms), and MRI images.

2. Designation of Measurement Site (Step S2)

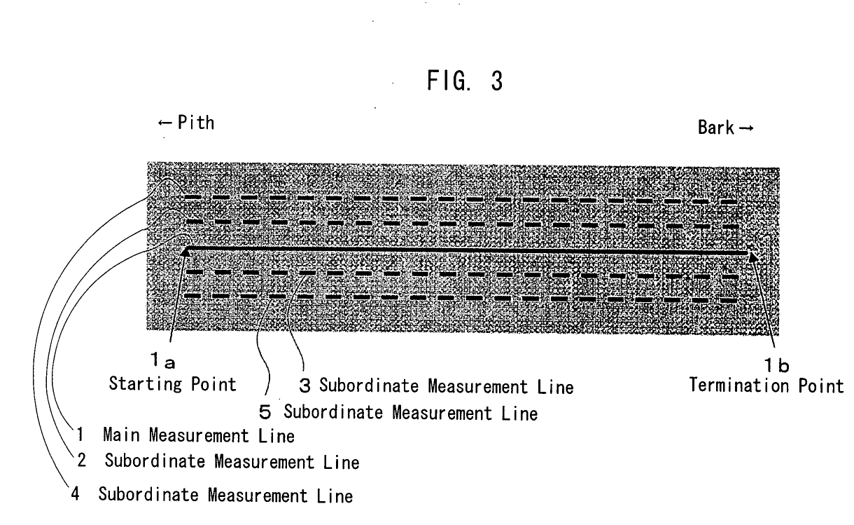

The measurement of tree ring width is conducted, as shown in FIG. 3, along at least one measurement line 1. On the cross section(transverse plane) disc, the measurement line is usually set from the pith (center left in FIG. 3) to the bark (center right in FIG. 3). On the radial section(longitudinal plane), the measurement line is set from the pith to the bark in a manner that intersects orthogonally with the grain. In the present invention, preferably, in order to improve the recognition performance, multiple subordinate measurement lines 2, 3, 4, and 5 are set on both sides of the single main measurement line 1, parallel to the main measurement line and spaced appropriately (see FIG. 3).

The appropriate number of subordinate measurement lines, according to our studies, has been confirmed to be two for the cross section and four for the radial section. However, given individual differences among specimens, this number is not necessarily appropriate for all cases. On the actual program, it is preferable to designate the spaces and numbers of the subordinate measurement lines, as well as the starting point la and termination point 1b of the main measurement line 1 on the tree ring image, to allow designation of the measurement area.

3. Acquisition of Pixel Information (Step S3)

As described above, the pixel information for each image (in the case of ordinary personal computers, the BGR 3 channel 8-bit digital signal) is acquired along the main measurement line 1 and the subordinate measurement lines 2 to 5. In relation to image acquisition, it is preferable to simultaneously acquire information on measurement line peripheral pixels for smoothing (the specific number of peripheral pixels is determined according to the level of smoothing) as described below, in addition to the pixel information on the measurement lines.

It should be noted that, since the tree ring recognition by the methods of the present invention does not use color information, it is possible to use averaged signals or mixed signals of BGR signals, or signals based on the light intensity of signals of certain channels only (for instance, G signal only). Ordinarily, it suffices to use a signal that is an averaged mixture of B:G:R=1:1:1.

4. Density Conversion (Step S5)

The pixel information acquired by the above method has the characteristic of being brighter as the value becomes greater, because the information is a result of the light intensity of each pixel. Furthermore, the RGB signal on the personal computer system has usually been processed via a nonlinear transformation called gamma correction in order to correct for the characteristics of the CRT monitor. On the other hand, since the light and dark contrast of tree rings is a result of the density of cells in the tree rings, it is usual practice in dendrochronology to describe light and dark contrast on the basis of density or image density which is related to density.

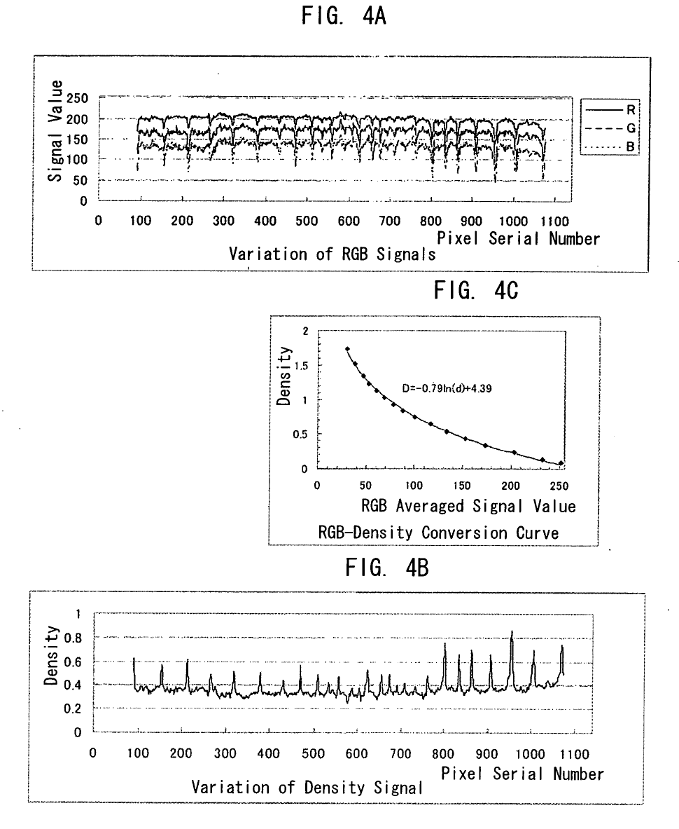

The description of density becomes darker as the value becomes greater. In the embodiment according to the present invention, this usual practice of dendrochronology is followed, and the red and green averaged signal (RGB averaged signal) is converted to density signal (see FIGS. 4A, 4B, and 4C). For the conversion method, the conversion formula derived from the known density portion of the image (usually step tablet chart) can be used. One example of the conversion formula is as follows:
D=−0.79×ln(d)+0.49 (11)
when : D is a density signal value, and d is a RGB averaged signal value
   In addition, a linear conversion such as the following may be used in place of a non-linear conversion.
   D=−βd+c (12)
when: β is a positive constant value, and c is a constant value

It should be noted that when conducting such image processing as binary coding, or when using conventional methods which necessitated the setting of a threshold value for tree ring recognition, the manner in which the tree ring signal waveform and amplitude characteristics were described was important.

However, as described below, since in the present invention tree ring recognition can be conducted without regard to the tree ring signal waveform value itself, there is no great difference in tree ring recognition performance whether the signal used is RGB, light intensity, or density. Therefore, in order to shorten the processing step or time, this process can be omitted. However, it should be kept in mind that omitting this process will cause the tree ring signal waveform to invert.

5. Smoothing (Steps S6 & S7)

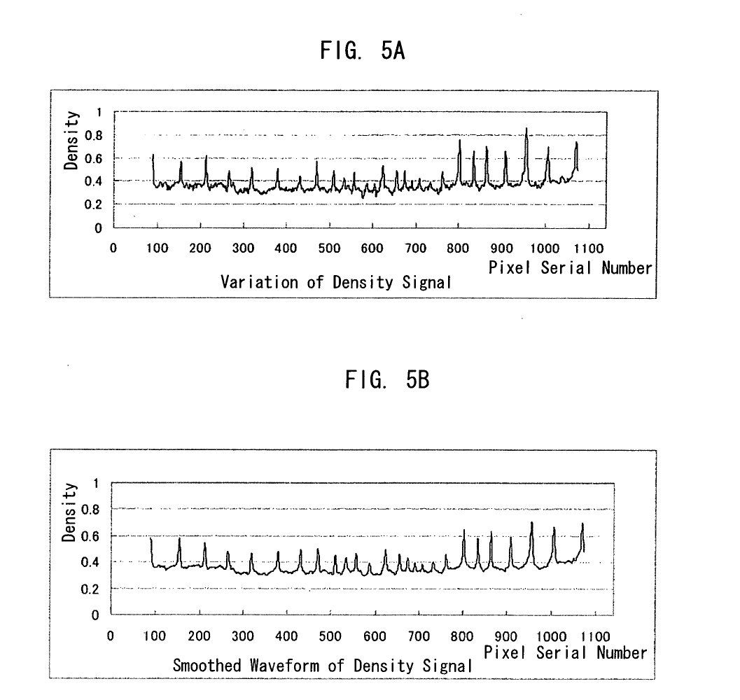

Smoothing is conducted using information of peripheral pixels on each of the pixel values obtained via the above process on the main measurement line 1 and subordinate measurement lines 2 to 5. By conducting smoothing, it is possible to reduce erroneous recognition attributable to noise resulting from the specimen itself or from the measuring equipment (see FIGS. 5A and 5B).

As the method of smoothing, the moving means or moving median may be used. As the number of peripheral pixels, for example in the case of 1,200 dpi resolution, in our experiment the following were appropriate: cross section, approx. 5 pixels in the direction orthogonal to the measurement line and approx. 3 pixels in the direction of the measurement line; and radial section, approx. 15 pixels in the direction orthogonal to the measurement line and approx. 5 pixels in the direction of the measurement line. However, these pixel numbers are not the only possibilities. It should be noted that when smoothing is not to be conducted, the smoothing range is to be set as 1 pixel each in the direction orthogonal to the measurement line and the direction of the measurement line.

6. Acquisition of Peak Signal or Edge Signal (Steps S8 through S12)

In the signal acquired through the above process, the maximum point of the waveform represents the densest portion of each tree ring (late wood maximum density portion). This density information signal shall hereinafter be referred to as the peak signal. By recognizing the peak point (maximum point of waveform), which is the feature point of the peak signal, it is possible to distinguish each tree ring layer.

On the other hand, the trough point (the minimum point of the waveform), which is the feature point of the differential signal (actually the signal obtained by calculus of finite differences) of the peak signal, corresponds to the point where the tree ring image shifts from the dark portion(high density portion) to the light portion(low density portion), and corresponds to the termination point of each tree ring layer (late wood end). This differential signal shall hereinafter be referred to as the edge signal.

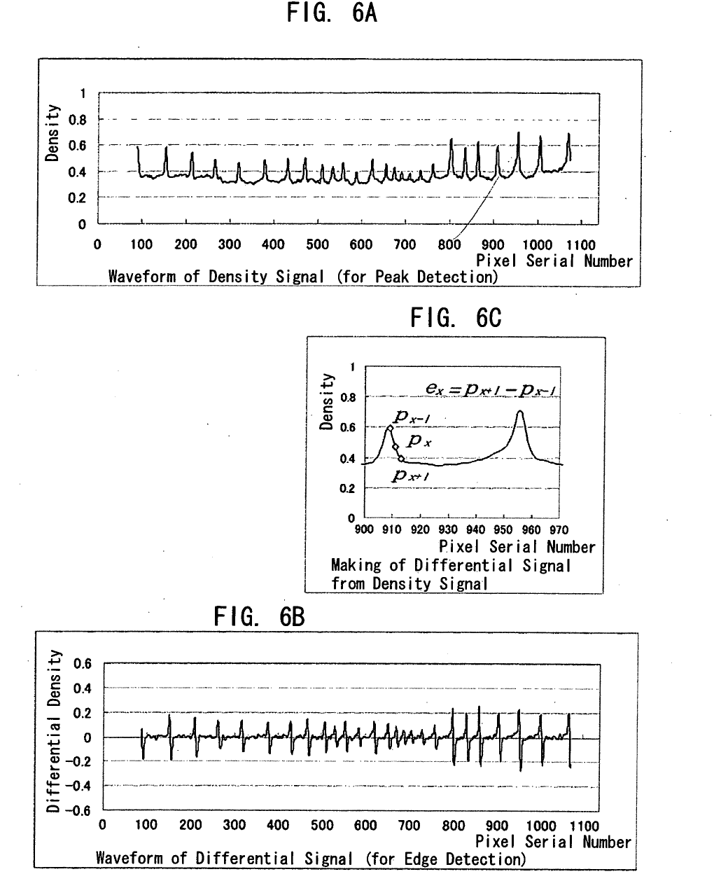

The ordinary differential signal is obtained by calculus of finite differences of adjacent pixels, but adjacent calculus of finite differences is prone to being affected by noise. Therefore, in the preferred embodiment of the present invention, efforts are made to reduce noise by conducting calculus of finite differences on multiple pixels spaced several pixels apart (see FIG. 6C).

When the peak signal (the waveform shown in FIG. 6A) and the edge signal (the waveform shown in FIG. 6B) are compared, the peak signal has better detection performance for the identification of each tree ring, due to the effect of waveform noise, etc., but from the perspective of measuring tree ring width with accuracy, the edge signal, which corresponds to the late wood end, has higher precision. Therefore, in the preferred embodiment of the present invention, these characteristics are maximized by allowing the user to select from the following on a menu: recognition by peak signal, recognition by edge signal, and recognition using a combination of both.

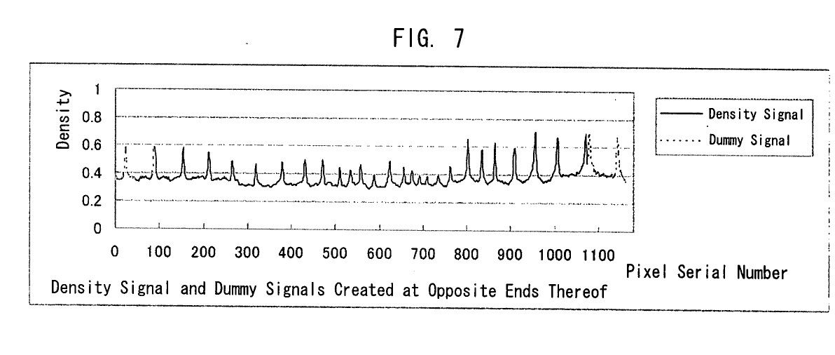

In the wavelet conversion(convolution integration operation) described in the following section “8. Wavelet conversion” operations are conducted on pixels of a single point including peripheral pixels. Therefore, it is desirable for a dummy signal (see the dotted line portions on both ends of the waveform in FIG. 7) to be created on both ends of the measurement line (starting point la and terminating point 1b in FIG. 3) by folding the signal back on itself, to prevent the operation from becoming inoperable due to lack of pixels. The length required for the dummy signal is dependent on the mother wavelet support designated below in “7. Designation of mother wavelet” and the level number designated in “8. Wavelet conversion”, but since the longest length of end processing is at the lowest level j, it suffices to extend the dummy signal accordingly.

7. Designation of Mother Wavelet (Step S13)

The function ψ(x) that can be used as the mother wavelet is a function that meets the following two conditions:
(a) The end portion of the function is 0 or converges on 0
(b) The sum total of all intervals (integral value) is 0.

In addition, it is desirable for the following condition to be met if possible, although it is not necessarily required:
(c) The support (the interval at which the function value is not 0) is compact.

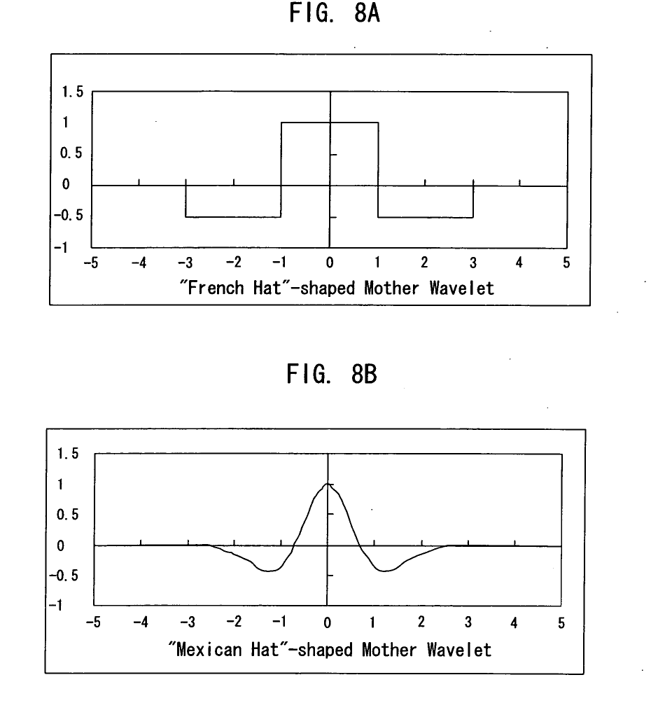

As concrete example of a mother wavelet, the following French hat wavelet transform (formula (13)) and Mexican hat wavelet transform (formula (14)) can be given(see FIGS. 8A and 8B).

$$\begin{matrix}ϕ ( x ) = \{ \begin{matrix}1 & - 1 \leq x \leq 1 \\ - 0.5 & - 3 \leq x < - 1 , or 1 < x \leq 3 \\ 0 & x < - 3 , or 3 < x\end{matrix} & ( 13 ) \\ ϕ ( x ) = - \frac{1}{2} \frac{{ⅆ}^{2}}{ⅆ {x}^{2}} {ⅇ}^{- {x}^{2}} = ( 1 - 2 {x}^{2} ) {ⅇ}^{- {x}^{2}} & ( 14 )\end{matrix}$$

In the preferred embodiment of the present invention, the French hat wavelet transform of the formula (13) is used as default, because it is easy to generate and its support is compact. Of course the Mexican hat wavelet transform and other mother wavelets can be used if designated.

8. Wavelet Conversion(Step S14)

The wavelet conversion for the one-dimensional image signal f(x) is defined by the following formula (15).
dⱼ(k)=2^{j}∫_{-∞}^{∞}φ(2^{j}(x−k))f(x)dx (15)

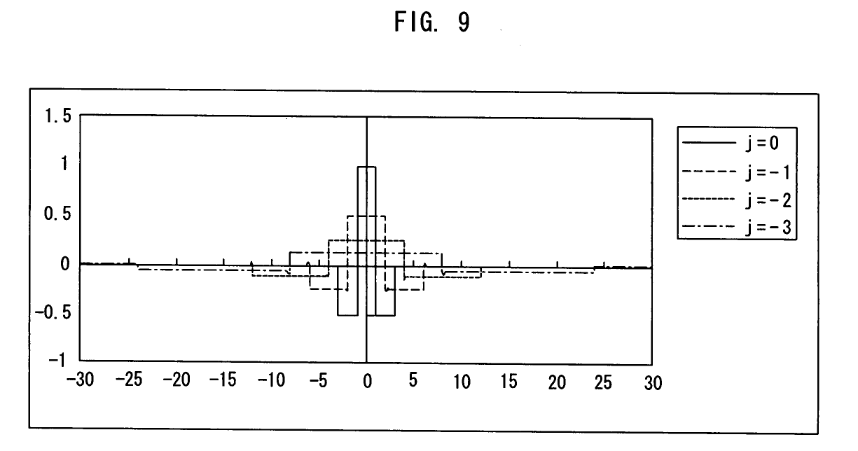

In the formula (14), f(x) is the peak signal or edge signal on the measurement line. In addition, as described in the above “6. Acquisition of Peak Signal or Edge Signal”, both ends of the signal have been appropriately treated by folding back on the signal itself. ψ(x) is the mother wavelet described in “7. Designation of Mother Wavelet”, 2^{j} is the scaling parameter, and the level (scale level) j is 0 or a negative whole number. By this scaling parameter, it is possible to change the width and height of the mother wavelet according to the power law of 2 while retaining the area unchanged (see FIG. 9). k indicates the translating parameter. It should be noted that while in the formula (15) the scaling parameter is 2^{j}, this is not the only possibility. It is also possible to have b^{j} (where b>1) and illustrate as in the following formula (16).
dⱼ(x)=b^{j}∫_{-∞}^{∞}φ(b^{j}(x−k))f(x)dx (16)

In the formula (16), when 1<b<2, the spaces between the steps of the scaling parameter become finer than with the formula (14), and when 2<b, the spaces between the steps of the scaling parameter become larger than in the formula (15).

As has been verified by our experiment, a good detection performance is usually obtained with the power of 2 step represented in the formula (15).

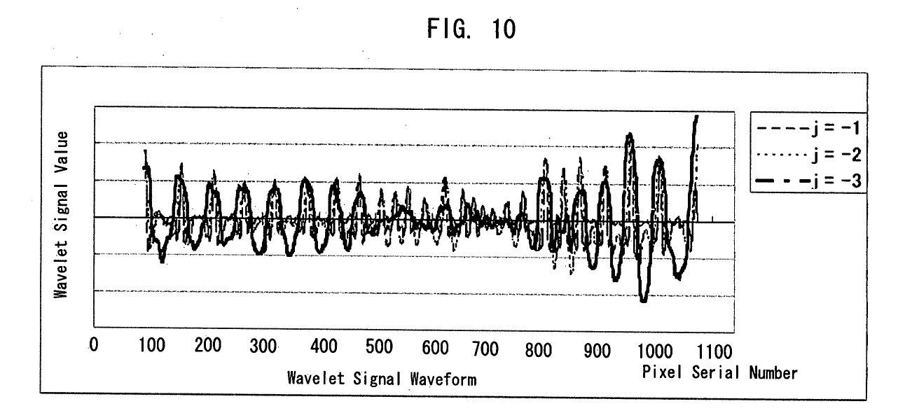

What is signified in the formula (15) and formula (16) is the convolution integration operation of and the mother wavelet ψ(x) which has had its size (stipulated by the scaling parameter) and position(stipulated by the translating parameter) changed, and the signal f(x) which is formed from the image. The dⱼ (x) that is generated by this operation has the characteristic of rippling violently when the local periodicity of f(x) and the support of the mother wavelet ψ(x) (the interval at which ψ is not 0) are roughly in coincidence (see FIG. 10).

In the treatment shown in FIG. 9 and FIG. 10, the level j is changed in three stages for ease of explanation and understanding; however, theoretically, when the level j is changed in eight stages, the following takes place,
2⁸⁻¹=2⁷=128 (17)
and tree ring widths of over 100-fold can be addressed. In our experiment, it was verified that setting the level j in eight stages enabled us to accommodate tree ring widths of 0.1 mm to over 1 cm. Therefore, the number of stages of level j can be set at any number according to the characteristics of the object to be measured.

9. Calculation of Squared Mean for Interval (Step S16)

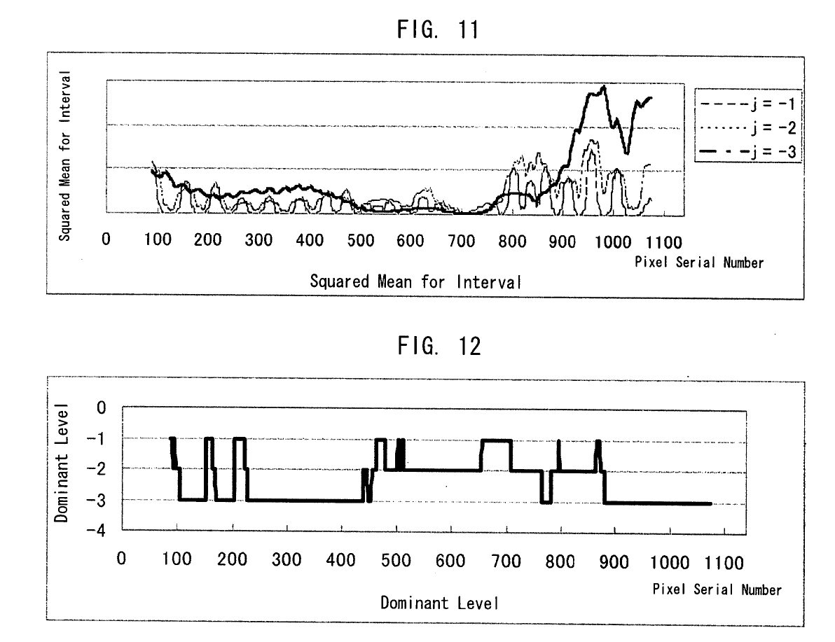

The squared mean for interval is calculated as shown in the following formula (18) for the dⱼ (x) generated by the “8. Wavelet Conversion” (see FIG. 11).
gⱼ(x)=2^{j-1}a⁻¹∫ₓ₋₂_{^{−j}}ₐ^{x+2}^{^{−j}}^{a}|dⱼ(k)|²dk (18)

Here, a is a constant that is determined by the support of the mother wavelet ψ(x).

In the formula (18) the interval for which the squared mean is calculated is from x−2^{-j}a to x+2−2a, but this is not the only possibility, and it can be defined as in the following formula (19).
gⱼ(x)=2⁻¹pⱼ⁻¹∫ₓ₋ₚ_{ⱼ}^{x+p}^{ⱼ}|dⱼ(k)|²dk (19)

That is, since the pⱼ is set in accordance with scale level j so that the pⱼ becomes larger as the scale level j becomes lower, it is acceptable to make the calculation of the squared mean for interval for narrow intervals [x−pⱼ, x+pⱼ] for dⱼ (x) of high frequency at high level j, and for broad intervals [x−pⱼ, x+pⱼ] for dⱼ f of low frequency at low level j. The integration interval of x−2^{-j}ₐ through to x+2^{-j}a, shown in the formula (18), is nothing but a standard integration interval. When the integration interval [x−pⱼ, x+pⱼ] is made narrower than this, it becomes more sensitive to local density changes, but more susceptible to the effects of noise. On the other hand, when the integration interval [x−pⱼ, x+pⱼ] is made broader than this, it loses its sensitivity to local density changes, but tends to become less susceptible to noise and more stable. Therefore, by adjusting the integration interval [x−pⱼ, x+pⱼ] from the above standard state, it is possible to adjust the sensitivity of detection.

10. Determination of the Dominant Level (Step S17)

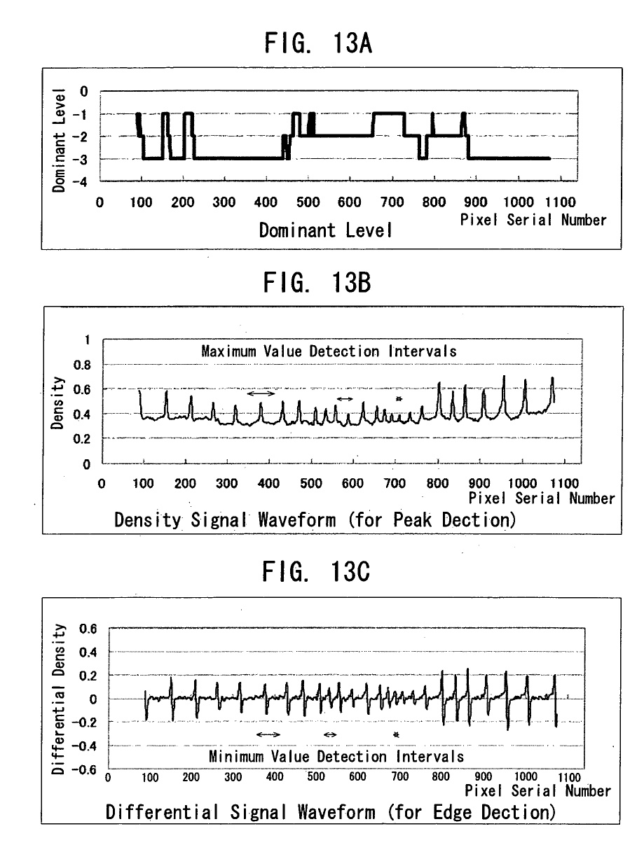

At a given point x, the level j at which the gⱼ (x) defined in the formula (18) or formula (19) becomes maximum is the dominant level j_{d}. Hence all points on the measurement line are made to have one dominant level (see FIG. 12). While the dominant level j_{d} tends to become lower at portions where the tree ring width is wide, it tends to become higher at portions where the tree ring width is narrow or in the vicinity of late wood where the signal changes markedly.

11. Determination of Maximum Value within the Interval (in the case of edge signal, the minimum value within the interval) (Steps S18 through S20)

As shown in FIGS. 13A, 13B, and 13C,

(a) When f(x) is a peak signal, when the value of f(x) is equivalent to the maximum value fₘₐₓ(x) of f(x) in the interval [x−2^{-jd}a, x+2^{-jd}a], then point x is determined as the point of maximum density within the tree ring layer.

(b) When f(x) is an edge signal, when the value of f(x) is equivalent to the minimum value fₘᵢₙ(x) of f(x) in the interval [x−2^{-id}a, x+2^{-jd}a], then point x is determined as the late wood end within the tree ring layer.

By conducting this operation throughout the entire range, it is possible to detect all tree rings on the measurement line.

It should be noted that while in the above (a) and (b), the b in the abovementioned scaling parameter b^{j} is 2, it can also be illustrated as follows.

(c) When f(x) is a peak signal, when the value of f(x) is equivalent to the maximum value fₘₐₓ(x) of f(x) in the interval [x−b^{-jd}, x+b^{-jd}], then point x is determined as the point of maximum density within the tree ring layer.

(d) When f(x) is an edge signal, when the value of f(x) is equivalent to the minimum value fₘᵢₙ(x) of f(x) in the interval [x−b^{-jd}, x+b^{-jd}], then point x is determined as the late wood end within the tree ring layer.

To further generalize this, it can be illustrated as follows using the constant q_{jd} that corresponds to the dominant level j_{d}.

(e) When f(x) is a peak signal, when the value of f(x) is equivalent to the maximum value fₘₐₓ(x) of f(x) in the interval [x−q_{jd}, x+q_{jd}], then point x is determined as the point of maximum density within the tree ring layer.

(f) When f(x) is an edge signal, when the value of f(x) is equivalent to the minimum value fₘᵢₙ(x) of f(x) in the interval [x−q_{jd}, x+q_{jd}], then point x is determined as the late wood end within the tree ring layer.

12. Cross-referencing of Main Measurement Line and Subordinate Measurement Lines (Step S21)

When the tree ring on the main measurement line 1 established in the above “2. Designation of Measurement Site” is unclear, efforts to detect the maximum density point and late wood end of each layer according to the procedures in the above “3. Acquisition of Pixel Information” through to “11. Determination of Maximum Value within the Interval (in the case of edge signal, the minimum value within the interval)” may not result in detection. In addition, partial unclarities of tree ring layers often occur randomly. This situation shall be referred to as non-detection.

In addition, when there are points on the main measurement line 1 where the wood tissue is not uniform, or where there are density changes outside of the natural tree rings, such as cracks or polish marks (hereinafter referred to as noise), points other than the maximum density point or late wood end may be detected. This situation shall be referred to as erroneous detection.

Normally, tree rings occur in concentric circles at the cross section and in parallel patterns at the radial section, while noise occurs in uncertain patterns. Taking advantage of these differences, verification is conducted as to whether a detection should be established as a tree ring, cross-referencing with the results of detection from the subordinate measurement lines configured in “2. Designation of Measurement Site” (the results of detection from each of the subordinate measurement lines 2 to 5 according to the procedure in the “3. Acquisition of Pixel Information” through to “11. Determination of Maximum Value within the Interval (in the case of edge signal, the minimum value within the interval)”) in order to ensure the output of correct detection results even in the event of non-detection or erroneous detection on the main measurement line. The specific procedures for the above are described below.

In the actual program, in order to conduct cross-referencing efficiently, the positions and measurement line numbers of detection points on all main and subordinate measurement lines are recorded in memory as establishment candidate points.

In the cross section, tree rings usually present a concentric circular pattern, but when considering an extremely small width, they can be regarded as being approximately parallel. The tree rings in the radial section are in a parallel pattern. However, since neither of them are in a complete parallel state, where they intersect orthogonally with the direction of the measurement line, there may be cases where there is a slight discrepancy between the detection position on the main measurement line and the detection position on the subordinate measurement lines. In order to absorb the error of the detection points, which should rightfully be the same tree ring layer, attributable to the different configuration position of the main or subordinate measurement lines, that is, in order to determine whether the detection point is within a roughly identical distance from the starting point of each measurement line, a width h, which can be regarded as being identical, is configured.

Next, a definition is made as to how many detection points must occur out of the multiple main and subordinate measurement lines in order for that detection point to be established as a correct detection point. In our experiment, we obtained the best results with domestically produced Japanese cypress (Hinoki) cypress when detection points occurred in at least two out of the three measurement lines (the main measurement line and two subordinate measurement lines) in the cross section, and when they occurred in at least three out of the five measurement lines (the main measurement line and four subordinate measurement lines) in the radial section. More generally, the correct detection point can be defined as the detection point that has at least m detection points out of the n number of main and subordinate measurement lines within the width ±h that can be regarded as being identical.

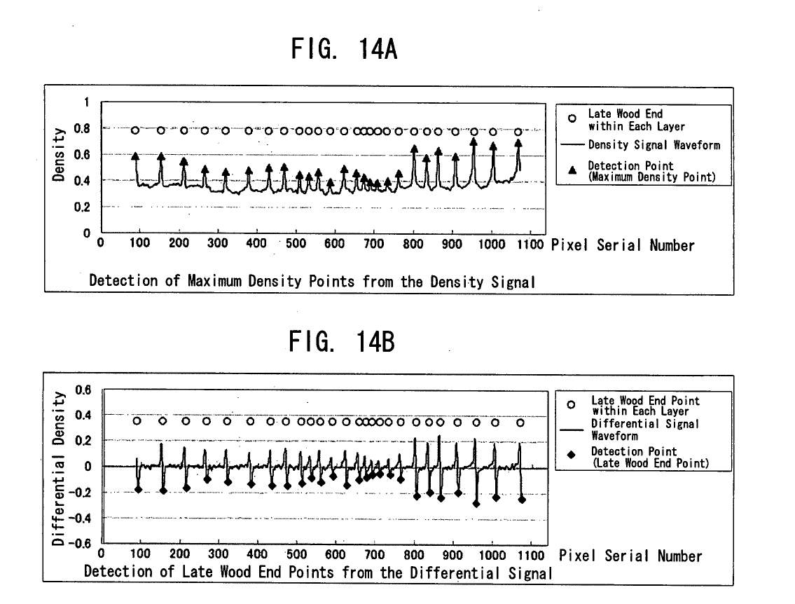

In accordance with the above rule, all the detection points on the main measurement line are subjected to analysis to establish those with detection points in at least m out of the n number of measurement lines within the width ±h as the correct tree ring (the maximum density point within each layer, or the late wood end within each layer) (see FIGS. 14A and 14B). Hence,

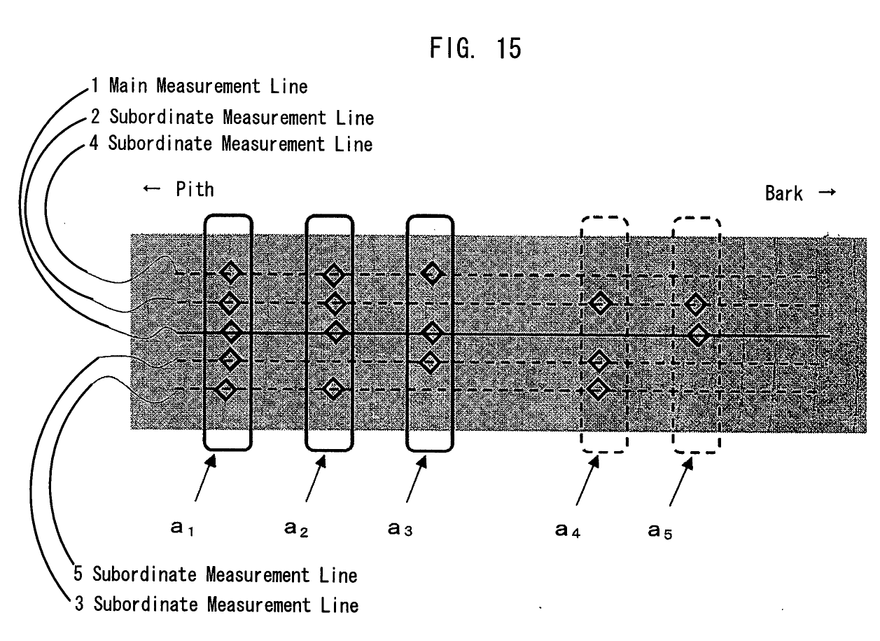

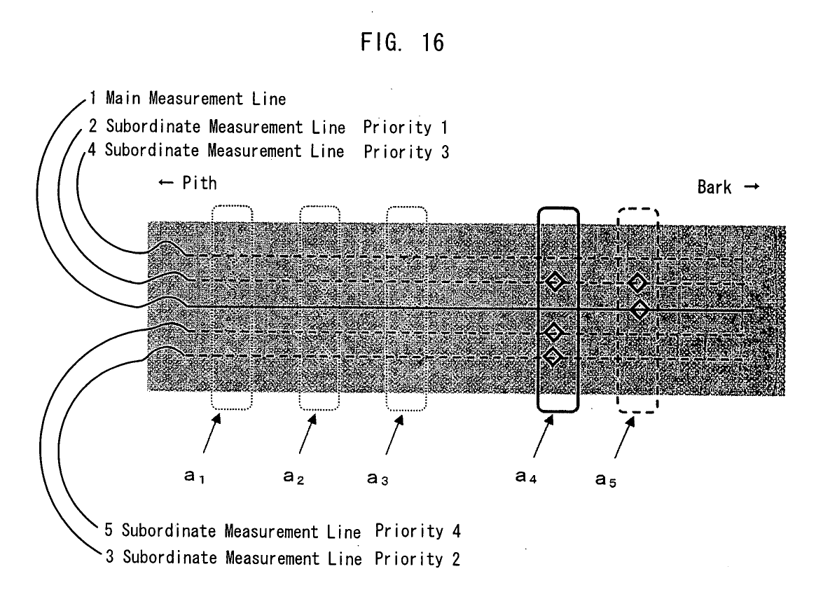

(1) when the detection point on the main measurement line is the correct tree ring, then it is established as correct by cross-referencing. For instance, in the example in FIG. 15, from detection points a₁ through to a₃ there is a detection point on the main measurement line as well as detection points on at least three of the five measurement lines, and therefore the detection point is established.

(2) when the detection point on the main measurement line is an erroneous detection, it is eliminated by cross-referencing. For instance, in the example in FIG. 15, since the detection point a₅ has points in less than three locations out of the five measurement lines, it is not established but is subjected to the following “13. Cross-referencing between Subordinate Measurement Lines”.

(3) when there is a non-detection on the main measurement line (see detection point a4 in FIG. 15), this situation is not considered in this process, and therefore the following “13. Cross-referencing between Subordinate Measurement Lines” is conducted.

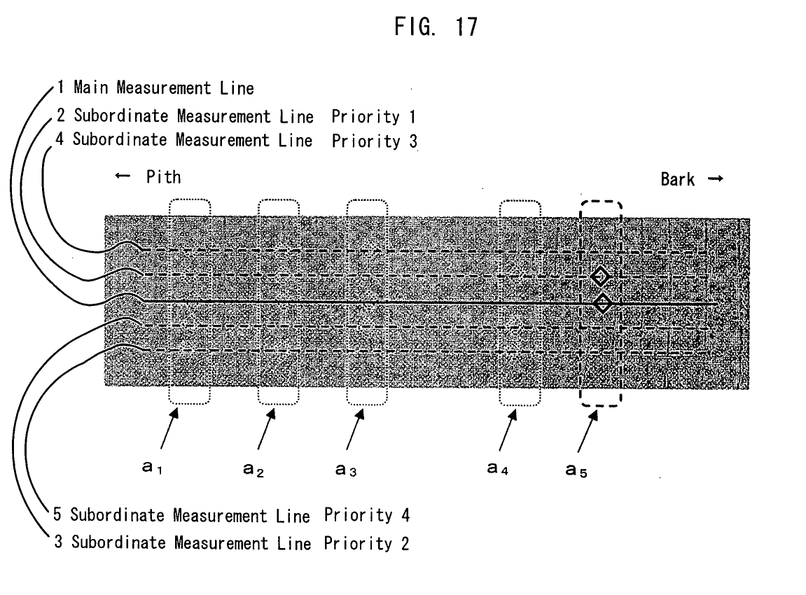

In “13. Cross-referencing between Subordinate Measurement Lines,” as shown in FIG. 16, because detection point a4 has detection points in at least three locations, it is established as priority 1 during the search. However, since detection point a₅ has points in less than three locations out of the five measurement lines, it is not established.

In the stage shown in FIG. 17, search points a₁ through to a₄ have already been established, while on the other hand, detection point a₅ is not established as a detection point, and cross-referencing is finished.

In order to conduct the following “13. Cross-referencing between Subordinate Measurement Lines” efficiently, those points that were established as correct tree rings in the process of “12. Cross-referencing of Main Measurement Line and Subordinate Measurement Lines” are deleted in sequence from the establishment candidate points.

13. Cross-referencing between Subordinate Measurement Lines (Step S22)

The multiple subordinate measurement lines 2 to 5 are prioritized in advance. Usually, the closer it is to the main measurement line 1, the higher it is ranked in priority. In prioritizing, it must be ensured that no two measurement lines have the same rank.

First, all the detection points remaining as establishment candidate points on the highest ranked subordinate measurement line are subjected to analysis to establish them as correct tree rings in accordance with the rule similar to that of “12. Cross-referencing of Main Measurement Line and Subordinate Measurement Lines” (see detection point a₄ in FIG. 16). Those points that were established as correct tree rings in this process are deleted in sequence from the establishment candidate points. A similar process is conducted in sequence from the highest priority down. This series of processes are finished when there are no more establishment candidate points, or when the process has been conducted on the lowest ranked subordinate measurement line (see FIG. 17). In reality, when the rule is “at least m out of n number of lines”, it is meaningless to conduct analysis on the lowest ranked m−1 number of lines including the lowest ranked line; therefore, it is acceptable to cut off analysis at this rank.

As described above, even in cases where there is a non-detection on the main measurement line in the process of “12. Cross-referencing of Main Measurement Line and Subordinate Measurement Lines”, it is established as a correct tree ring by conducting “13. Cross-referencing between Subordinate Measurement Lines” (see detection point a₄ in FIG. 15 and FIG. 16).

14. Determination of Tree Ring Location(Step S23)

The established tree ring points of “12. Cross-referencing of Main Measurement Line and Subordinate Measurement Lines” and “13. Cross-referencing between Subordinate Measurement Lines” are consolidated to make the tree ring point (the maximum density point within each layer, or the late wood end within each layer) (see FIGS. 14A and 14B). The establishment points established on the subordinate measurement lines in the process of the above “13. Cross-referencing between Subordinate Measurement Lines” are projected onto the main measurement line at the time of consolidation.

15. Measurement of Tree Ring Width and Output of Results (Steps S24 and S25)

Because all the information on established tree ring points is amassed on the main measurement line 1, the number of pixels of each layer is counted from the coordinate value of each established tree ring point on the main measurement line. Because the size per pixel is determined by the image resolution set in the above “1. Acquisition of Tree Ring Image”,

$$( Tree ring width ) = ( \begin{matrix}number of pixels \\ per layer\end{matrix} ) \times ( size per pixel ) \qquad ( 20 )$$

allows for the calculation of the tree ring width of each layer. By output of this result, the entire process is completed.

Incidentally, tree ring width is not the only data that is useful in dendrochronology. Other important data include maximum density within the layer, minimum density within the layer, and early wood/late wood ratio.

The effect of the method for the measurement of waveform signal feature points by the process described above is shown in Table 1 and Table 2.

TABLE 1
Results of detection of maximum density point using density signal

| | | | Rate of detection or erroneous detection [%] | | | | | | | |
|---|---|---|---|---|---|---|---|---|---|---|
| | | | | | | | | | New method | |
| | | | Conventional | | New method | | New method | | (use of wavelet and | |
| | | | method | | (wavelet only) | | (cross referencing only) | | cross referencing) | |
| | | | | Rate of | | Rate of | | Rate of | | Rate of |
| | Measurement | Number of | Rate of | erroneous | Rate of | erroneous | Rate of | erroneous | Rate of | erroneous |
| Specimen | surface | tree rings | detection | detection | detection | detection | detection | detection | detection | detection |
| 1 | Cross section | 108 | 97.2 | 2.8 | 100.0 | 0.0 | 99.1 | 0.0 | 100.0 | 0.0 |
| | Radial section | 109 | 87.1 | 7.8 | 99.0 | 1.8 | 97.2 | 1.9 | 100.0 | 0.9 |
| 2 | Cross section | 109 | 97.3 | 1.9 | 100.0 | 0.0 | 99.1 | 0.0 | 100.0 | 0.0 |
| | Radial section | 109 | 98.2 | 1.8 | 98.2 | 0.0 | 98.2 | 0.9 | 98.2 | 0.0 |
| 3 | Cross section | 163 | 100.0 | 0.6 | 100.0 | 0.0 | 100.0 | 0.0 | 100.0 | 0.0 |
| | Radial section | 163 | 97.6 | 1.2 | 98.8 | 0.6 | 98.2 | 0.6 | 100.0 | 0.0 |

TABLE 2
Results of detection of late wood end using differential signal

| | | | Rate of detection or erroneous detection [%] | | | | | | | |
|---|---|---|---|---|---|---|---|---|---|---|
| | | | | | | | | | New method | |
| | | | Conventional | | New method | | New method | | (use of wavelet and | |
| | | | method | | (wavelet only) | | (cross referencing only) | | cross referencing) | |
| | | | | Rate of | | Rate of | | Rate of | | Rate of |
| | Measurement | Number of | Rate of | erroneous | Rate of | erroneous | Rate of | erroneous | Rate of | erroneous |
| Specimen | surface | tree rings | detection | detection | detection | detection | detection | detection | detection | detection |
| 1 | Cross section | 108 | 96.3 | 3.7 | 99.1 | 0.9 | 98.1 | 0.9 | 100.0 | 0.0 |
| | Radial section | 109 | 83.5 | 10.8 | 96.3 | 2.8 | 94.5 | 4.6 | 99.1 | 1.8 |
| 2 | Cross section | 109 | 95.4 | 2.8 | 99.1 | 0.0 | 98.2 | 0.9 | 100.0 | 0.0 |
| | Radial section | 109 | 96.3 | 3.7 | 98.2 | 0.9 | 97.2 | 1.9 | 98.2 | 0.9 |
| 3 | Cross section | 163 | 99.4 | 1.2 | 100.0 | 0.0 | 99.4 | 0.0 | 100.0 | 0.0 |
| | Radial section | 163 | 96.3 | 2.5 | 98.8 | 1.2 | 98.8 | 1.2 | 100.0 | 0.6 |

Table 1 shows the results of detection of maximum density points when the above mentioned density point is used as a waveform signal, compared against detection results using the conventional method. Table 2 shows the results of detection of maximum late wood end when the above mentioned differential signal is used as a waveform signal, compared against detection results using the conventional method. In Table 1 and Table 2, the new method according to the present invention is separated into wavelet conversion only (cross-referencing of multiple measurement lines omitted), cross-referencing of multiple. measurement lines only (no wavelet conversion), and the combined use of wavelet conversion and cross-referencing of multiple measurement lines.

TABLE 3
Definitions: Rates of detection, erroneous
detection and non-detection

Detection

| | | Detected | Not detected |
|---|---|---|---|
| Input | Tree ring | [symbol] S | [symbol] N |
| | Not tree ring | [symbol] S | [symbol] N |

The rate of detection, rate of erroneous detection, and rate of non-detection shown in the above Table 1 and Table 2 are defined by the method shown in the following formulas (21), (22), and (23) from the relationship of Ss, Sn, Ns, and Nn shown in the above Table 3.
Rate of detection=Ss/(Ss+Sn) (21)
Rate of erroneous detection=Ns/(Ss+Ns) (22)
Rate of non-detection=Sn/(Ss+Sn) (23)

As can be understood from the above Table 1 and Table 2, it was verified that in all cases, using the measurement method of the present invention resulted in increased rate of detection and decreased rate of erroneous detection and rate of non-detection, and it was proven that detection performance improved overall.

The above has been a detailed description of measuring tree ring width, and if the process up to and including “14. Determination of Tree Ring Location” can be conducted with accuracy, it is easily possible to calculate, from peak signals and edge signals, characteristic quantities other than these tree ring widths.

In addition, the measurement method and measurement equipment according to the present invention are not limited in their use to tree ring measurement of wood specimens, but can also be applied to such uses as measurement of fingerprints, voice prints, and retina patterns for authentication purposes, measurement of wiring patterns in electronic components, and measurement of such biological signals as brain waves.

### INDUSTRIAL APPLICABILITY

As is clear from the above description, the method and equipment for the measurement of waveform signal feature points according to the present invention allows for accurate detection of the feature points of peak waveform signal even when the waveform signal is irregular in its distance between feature points; therefore, it is possible to markedly improve the detection performance of tree rings etc. in wood specimens.

That is, before incorporating wavelet conversion into the measurement method, tree ring detection was conducted by simple binary coding wherein a threshold value was established on f(x) and a given value was distinguished by being either over or under the threshold value, therefore having the drawbacks of being extremely vulnerable to noise and/or indistinct tree rings, and of the threshold value tending to be dependent on differences between individual specimens; however, by incorporating the measurement method using the wavelet conversion according to the present invention, it is possible to conduct tree ring detection while automatically adapting to the fineness (or coarseness) of the tree rings, or the clarity (or indistinctness) of the tree rings, as each situation arises, which contributes to the improvement in detection performance.

In addition, since this detection performance does not require the setting of a threshold value, it has a robust aspect that is not easily swayed by differences between individual specimens, and in this respect also is extremely innovative and effective.

What is claimed is:

1. A method for measuring feature points of a waveform signal having irregular feature point values or irregular distances between the feature points, said method comprising the steps of: performing wavelet conversion of the waveform signal within a predetermined interval by using a predetermined mother wavelet and multiple scale levels; calculating squared mean for interval for each interval width corresponding to said scale levels in relation to a wavelet conversion signal for each scale level generated by the said wavelet conversion; defining a scale level at a point where the calculated value of the said squared mean for interval becomes maximum at an arbitrary point within the predetermined interval, as a dominant level for that point; and detecting points at which the said waveform signal reaches maximum value or minimum value for each interval width corresponding to the dominant level, as the feature points of the waveform signal.

2. The method for measuring feature points of a waveform signal as set forth in claim 1, wherein said wavelet conversion uses the following formula (1) , that is,
dⱼ(x)=b^{j}∫_{-∞}^{∞}φ(b^{j}(x<k))f(x)dx (1)
where f(x) is the waveform signal, ψ(x) is the mother wavelet, b^{j} is a scaling parameter, b is a constant (b>1), j is a scale level comprised of zero or a negative whole number, and k is a translating parameter.

3. The method for measuring feature points of a waveform signal as set forth in claim 2, wherein said mother wavelet uses a French hat wavelet transform which is defined by the following formula (2), that is,
$$ϕ ( x ) = \{ \begin{matrix}1 & - 1 \leq x \leq 1 \\ - 0.5 & - 3 \leq x < - 1 , or 1 < x \leq 3 \\ 0 & x < - 3 , or 3 < x\end{matrix} \qquad ( 2 )$$

4. The method for measuring feature points of a waveform signal as set forth in claim 2, wherein said mother wavelet is a Mexican hat wavelet transform which is defined by the following formula (3), that is,
$$ϕ ( x ) = - \frac{1}{2} \frac{{ⅆ}^{2}}{ⅆ {x}^{2}} {ⅇ}^{- {x}^{2}} = ( 1 - 2 {x}^{2} ) {ⅇ}^{- {x}^{2}} \qquad ( 3 )$$

5. The method for measuring feature points of a waveform signal as set forth in claim 2, wherein said calculation of the squared mean for interval uses the following formula (4), that is,
gⱼ(x)=2⁻¹pⱼ⁻¹∫ₓ₋ₚ_{ⱼ}^{x+p}|dⱼ(k)|²dk (4)
where j is the scale level used in the formula (1), k is the translating parameter, and pⱼ is a constant that is set according to scale level j so that the constant pⱼ becomes larger as the scale level j becomes lower.

6. The method for measuring feature points of a waveform signal as set forth in claim 5, wherein pⱼ in said formula (4) for the calculation of the squared mean for interval is defined by the following formula (5), that is,
pⱼ=b^{-j}a (5)
where a is a constant determined by the support of the mother wavelet ψ(x) used in the formula (1), b is the constant used in the formula (1), and j is the scale level used in the formula (1).

7. The method for measuring feature points of a waveform signal as set forth in claim 2 or 5, wherein the value of b in said formula (1) is 2.

8. The method for measuring feature points of a waveform signal as set forth in claim 1, wherein said waveform signal is a pixel light intensity or density information signal acquired from a target image such as wood specimen tree ring images or the like along a measurement line configured on said image.

9. The method for measuring feature points of a waveform signal as set forth in claim 1, wherein said waveform signal is a pixel light intensity or density information signal acquired from a target image such as wood specimen tree ring image or the like along a measurement line configured on said target image that is further subjected to differential processing.

10. The method for measuring feature points of a waveform signal as set forth in claim 9, wherein said differential processing is a calculus of finite differences between multiple pixels separated by an interval of several pixels.

11. The method for measuring feature points of a waveform signal as set forth in claim 8, wherein when said waveform signal is a density information signal, said density information signal is f(x), said dominant level is j_{d}, a constant corresponding to said dominant level is q_{jd}, and an arbitrary point on said measurement line is x, then when the value of f(x) is equivalent to the maximum value fₘₐₓ(x) of f(x) of the interval [x−q_{jd}, x+q_{jd}], the point x is determined as the feature point which indicates the maximum density point within the tree ring layer.

12. The method for measuring feature points of a waveform signal as set forth in claim 9, wherein when said waveform signal is a differential signal obtained by differential processing of a density information signal, said differential signal is f(x), said dominant level is id, the constant corresponding to said dominant level is q_{jd}, and an arbitrary point on said measurement line is x, then when the value of f(x) is equivalent to the minimum value fₘᵢₙ(x) of f(x) of the interval [x−q_{jd}, x+q_{jd}], the point x is determined as the feature point which indicates the late wood end within the tree ring layer.

13. The method for measuring feature points of a waveform signal as set forth in claim 8 or 9, wherein said measurement line is comprised of a main measurement line and multiple subordinate measurement lines which are equidistant parallel lines on either side of said main measurement line, and when waveform signal feature points are detected at a point that is the same distance from the starting end on said main measurement line and subordinate measurement lines, then those feature points are determined to be a feature point on the main measurement line provided that one of the conditions is that the number of said feature points comprises at least a majority in relation to the number of measurement lines including the main measurement line and subordinate measurement lines.

14. The method for measuring feature points of a waveform signal as set forth in claim 13, wherein two subordinate measurement lines are configured respectively at both sides of said main measurement line, and when waveform signal feature points are detected at a point that is roughly the same distance from the starting end on said main measurement line and subordinate measurement lines, and when feature points are found on the main measurement line and on at least one of the two subordinate measurement lines that are positioned adjacent to said main measurement line, and on at least one of the other subordinate measurement lines, and when feature points are found on the two subordinate measurement lines that are positioned adjacent to the main measurement line, and on the other subordinate measurement line, those feature points are determined to be a feature point on the main measurement line.

15. The method for measuring feature points of a waveform signal as set forth in claim 8 or 9, wherein a smoothing process using peripheral pixel information is performed on the pixel light intensity or density information acquired from the target image along the measurement lines configured on the target image.

16. An equipment for measuring feature points of a waveform signal having irregular feature point values or irregular distances between feature points, comprising: a wavelet conversion means for performing wavelet conversion of a waveform signal within the predetermined interval by using a predetermined mother wavelet and multiple scale levels; a squared mean calculation means for calculating squared mean for interval for each interval width corresponding to said scale levels in relation to the wavelet conversion signal for each scale level generated by the wavelet conversion means; a dominant level decision means for defining a scale level at which the calculated value of the aforementioned squared mean for interval becomes maximum at an arbitrary point within the aforementioned predetermined interval, as the dominant level for that point; and feature point detecting means for detecting points at which the aforementioned waveform signal reaches maximum value or minimum value for each interval width corresponding to the dominant level, as the feature points of the waveform signal.

17. The equipment for measuring feature points of a waveform signal as set forth in claim 15 further comprising distance calculating means for calculating distances between the feature points on the basis of the detected feature points of the waveform signal.
